(19) United States
(12) Patent Application Publication
(10) Pub. No.: US 2008/0018880 A1
(43) Pub. Date: Jan. 24, 2008

(54) SURVEYING APPARATUS

(75) Inventors: Shunji Matsuo, Tokyo (JP); Homu Takayama, Saitama (JP); Takanori Yachi, Tokyo (JP); Masatoshi Sakurai, Saitama (JP)

Correspondence Address: GREENBLUM & BERNSTEIN, P.L.C., 1950 ROLAND CLARKE PLACE, RESTON, VA, 20191, US

(73) Assignee: PENTAX INDUSTRIAL INSTRUMENTS CO., LTD., Tokyo (JP)

(21) Appl. No.: 11/772,369

(22) Filed: Jul. 2, 2007

(30) Foreign Application Priority Data
Jul. 3, 2006 (JP) P2006 - 183934

(51) Int. Cl. G01C 3/08

(52) U.S. Cl. 356/4.01

(57) ABSTRACT

A surveying apparatus is provided having a telescope, a digital camera, a display device, a measuring device, and a superimposing device. The telescope collimates the aiming point on a surveying object. The digital camera has an imaging optical system provided independently from the telescopic optical system of the telescope. The display device displays an image captured by the digital camera. The measuring device measures the distance between the telescope and a surveying point to be surveyed. The superimposing device displays a shot mark which roughly indicates the location of the surveying point in the image on the display device.

### BACKGROUND OF THE INVENTION

1. Field of the Invention

The present invention relates to a surveying apparatus having an image-capturing apparatus.

2. Description of the Related Art

A surveying apparatus, e.g. a total station, surveys a surveying object by collimating an aiming point on the surveying object using a collimator provided in a telescope. The purpose of the survey is to measure the distance between a surveying origin and the object to be surveyed (surveying object). A total station emits a laser beam towards the surveying object, and observes the laser beam reflected from the surveying object.

Some total stations have a digital camera. Light entering a telescope is divided by a prism, and some of the divided light is guided to a digital camera. The digital camera has lenses hawing a wider view angle than a scope, and photographs an image in which the aiming point of the optical axis of the telescopic lens is centered, and displays the photographed image on a display provided in the total station. A user can approximately direct the total station towards the object by looking at the image on the display, and precisely direct it at the object by using the scope. The aiming point is aligned with the object for collimating. After the survey, the digital camera stores a recorded image to a memory medium provided in the total station.

When a user surveys an object using a reflector-less mode, the total station receives a reflected laser beam, which was emitted towards a surveying object by the total station, without utilizing a reflecting prism. When using the reflector-less mode, it is not required to provide a reflecting prism on the surveying object. The reflector-less mode is utilized for surveying planimetric features or the corner of a construction on which a reflecting prism cannot be provided. After a user surveys these objects, it may be difficult to identify the aiming point on a display or recorded image. A total station displaying the surveyed point of a recorded image shown on a display is disclosed in Japanese Unexamined Patent Publication (KOKAI) No. 2004-340736.

### SUMMARY OF THE INVENTION

An object of the present invention is to provide a surveying apparatus, using which a user is able to recognize the rough location of the aiming point without difficulty.

According to the present invention, there is provided a surveying apparatus comprising a telescope, a digital camera, a display device, a measuring device, and a superimposing device. The telescope collimates the aiming point on a surveying object. The digital camera has an imaging optical system provided independently from the telescopic optical system of the telescope. The display device shows an image captured by the digital camera. The measuring device measures the distance between the telescope and the surveying point to be surveyed. The superimposing device displays a shot mark which roughly indicates the location of the surveying point in the image on the display device.

### BRIEF DESCRIPTION OF THE DRAWINGS

The objects and advantages of the present invention will be better understood from the following description, with reference to the accompanying drawings in which:

FIG. 1 is a block diagram showing the total station as an embodiment of the present invention;

FIG. 2 is a front view of the total station;

FIG. 3 is a flowchart showing the superimposing process;

FIG. 4 is a pattern diagram showing the physical relationship between the imaging optical system, the telescopic optical system, the surveying object, and the aiming point;

FIG. 5 shows a representation of an image displayed on the camera display;

FIG. 6 shows a representation of a stored image onto which a point mark is superimposed;

FIG. 7A shows an image as displayed on the camera display before a point mark corresponds to an aiming point;

FIG. 7B shows an image as displayed on the camera display when a point mark corresponds to an aiming point;

FIG. 8 shows an image onto which a shot mark is superimposed in a corrected on the camera display; and

FIG. 9 shows an image onto which a shot mark is located on the center of the camera display.

### DESCRIPTION OF THE PREFERRED EMBODIMENTS

The present invention is described below with reference to the embodiments shown in the drawings.

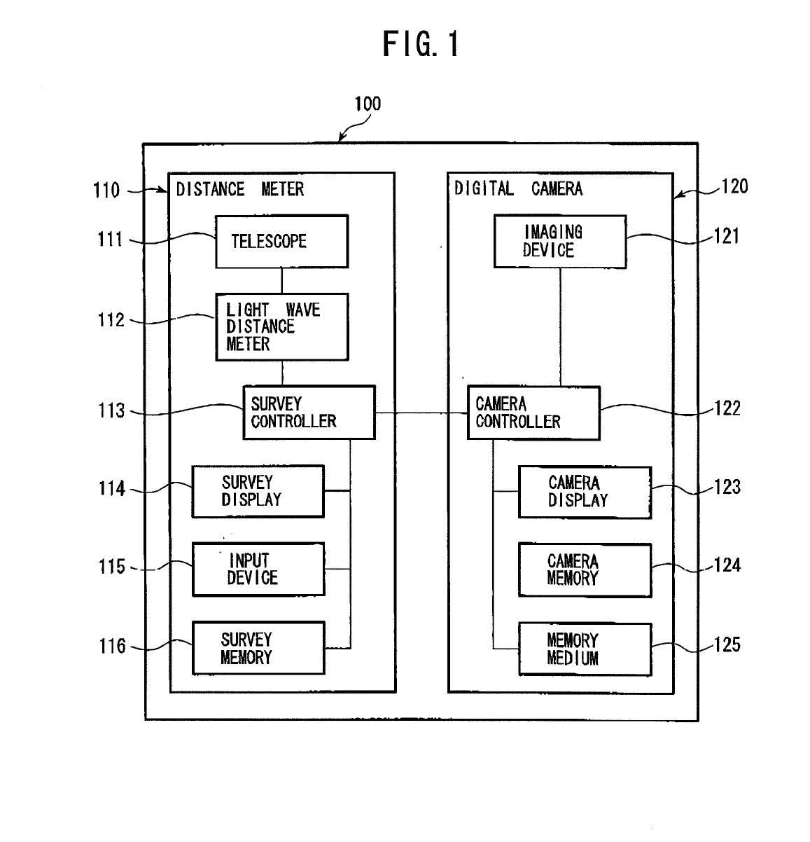

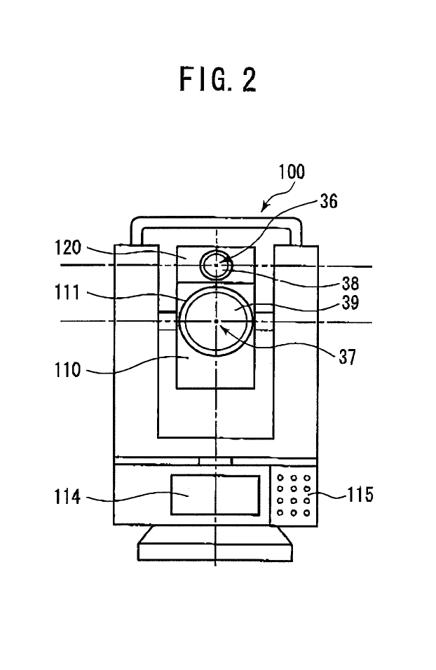

The constitution of a total station is described with reference to FIGS. 1, 2, and 4.

A total station comprises a distance meter 110 and digital camera 120. A distance meter includes a telescope 111, having a telescopic optical system. A user collimates the aiming point 34 on a surveying object 33 using the telescopic optical system 39. A surveying object 33 can be a planimetric feature or a corner cube. The aiming point 34 is a point provided on the optical axis of the telescope for collimating. The digital camera 120 captures an image using an imaging device 121.

A user directs a laser beam towards a collimated surveying object 33 using an input device 115. Laser beams are reflected by the surveying object 33, and enter the telescope 111. A laser beam entering the telescope 111 is guided to a light wave distance meter, and the phase of the laser beam is measured. The measured phase is stored temporarily in a survey memory 116, and then transferred to a survey controller 113. The survey controller 113 calculates the distance between the total station 100 and the surveying object 33. The survey controller 113 displays measuring data, information for controlling the total station 100, and any other relevant information, on a display 114. The total station 100 is operated using an input device 115, e.g. a keyboard. Surveying results data is stored in a memory medium 125 as measuring data, and the memory medium 125 is provided detachably in the digital camera 120.

The imaging device provided in the digital camera 120 comprises lenses, being a part of an imaging optical system, and a CCD image sensor (not shown) which convert light inputted through a lens into an electrical signal. An optical axis 36 of the imaging optical system 38 passes through the center of the effective pixel area of the CCD image sensor provided in the imaging device. The center of the photographed image corresponds to a point on the optical axis 36.

The imaging optical system 38 is independent from the telescopic optical system 39. Therefore, the light entering the telescope does not need to be divided, and the amount of light is sufficient for surveillance. Consequently, the surveying object 33 in properly visible to the telescopic optical system 39, and the imaging optical system 38 has a wider angle of view than that of the telescopic optical system 39.

A photographed image is stored temporarily in the camera memory 124, and processed by a camera controller 122 provided in the digital camera 120. Processed image data is displayed on a camera display 123 provided in the digital camera 120 as an image, and stored in the memory medium 125 as a recorded image. The memory medium 125 is provided detachably in the digital camera 120. Any photographing process executed in the digital camera 120, e.g. an imaging process, or a storing process, is executed by the user operating an input device 115 provided in the distance meter 110.

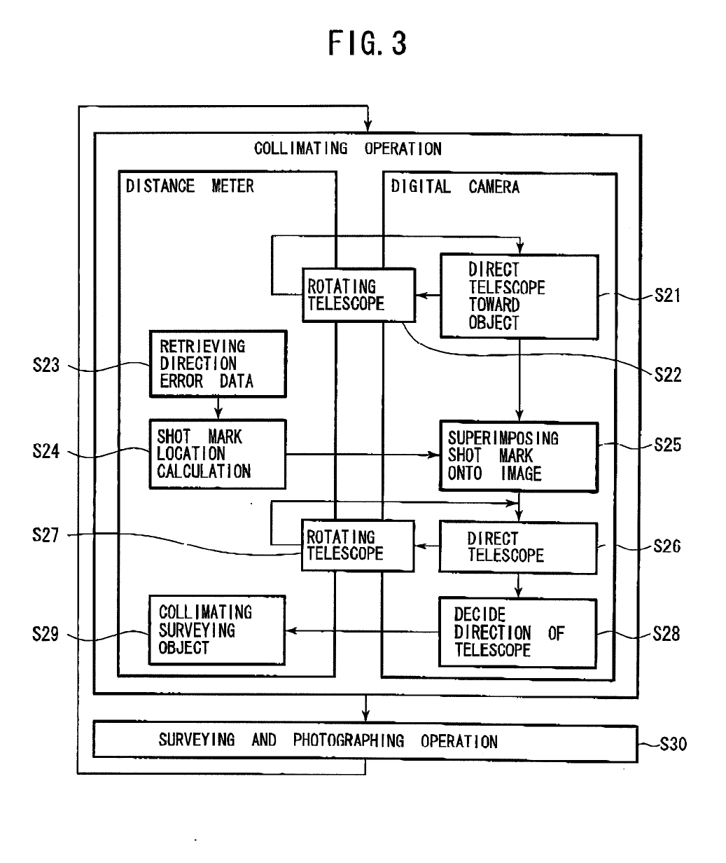

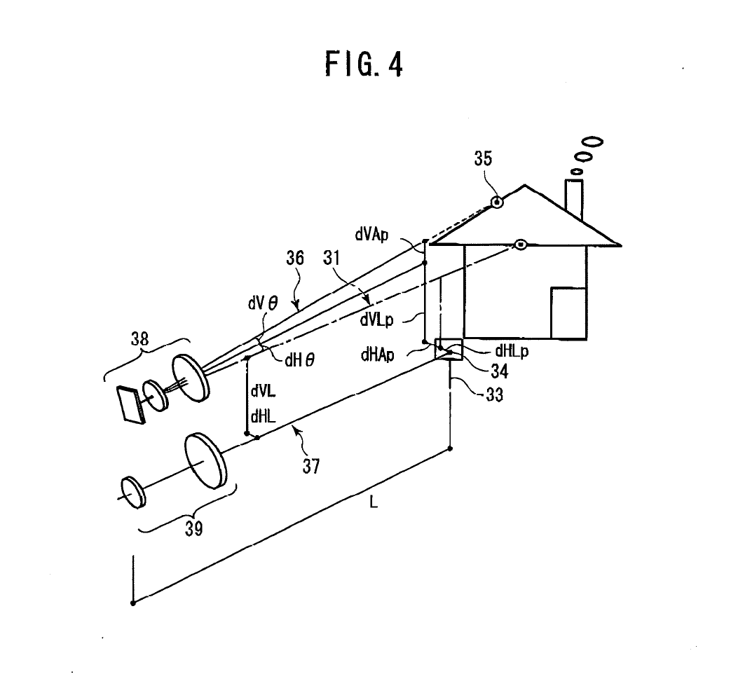

The superimposing process that displays a shot mark which indicates the corrected position on a camera display 123 is described below with reference to FIGS. 3 and 4.

A collimation begins by a user directing the telescope 111 towards the surveying object 33 by rotating it horizontally and vertically, guided by eye, as in step S21 and S22. In step S23, direction error data is retrieved from the survey memory 116. Direction error data is a vector quantity which was calculated by a process described below in a former survey and stored in the survey memory.

In step S24, the position of a shot mark on a recorded image is calculated by the process described below. A shot mark is a symbol used to roughly indicate the aiming point 34.

In step S25, the shot mark 43, superimposed onto an image at a calculated position by a known process, is shown on the camera display 123. The shot mark is represented by a cross.

In steps S26 and S27, a user directs the telescope 111 towards a surveying object 33 by rotating vertically and horizontally while observing the image shown on the camera display 123. Therefore, the position of the shot mark on the image does not include any direction errors.

A user can roughly direct the telescope 111 towards the surveying object 33 with reference to a shot mark located in a position in which direction errors are not included, and roughly decide the direction of a telescope 111 in step S28. Direction errors (dHAp, dVAp) are vector quantities which indicate an error between the optical axis 37 of the telescopic optical system 39 and the optical axis 36 of the imaging optical system 38.

A user collimates the aiming point 34 at the surveying object 33 using the telescope 111 in step S29. This completes preparation for surveying, and the surveying object 33 is surveyed in step S30.

Next, the axis error detecting process is described with reference to FIG. 4-7. FIG. 4 is a pattern diagram showing the optical axis 36 of the imaging optical system 38 of the digital camera 120, the optical axis 37 of the telescopic optical system 39 in a collimator, the aiming point 34, and the surveying object 33.

The axis error detecting process in executed before the superimposing process in executed. The aiming point 34 is collimated on the surveying object 33 in FIG. 4.

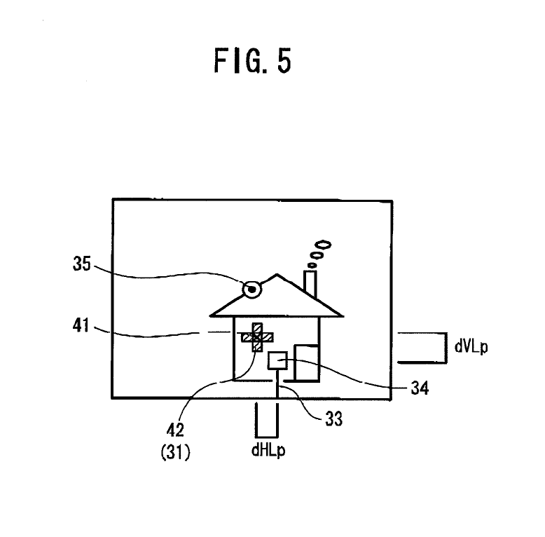

Offset quantities dHL and dVL, i.e. quantities of parallax, exist between the optical axis 37 of the telescopic optical system 39 and the optical axis 36 of the imaging optical system 38 because they are provided independently. Therefore, the aiming point 34 on the optical axis 37 of the telescopic optical system 39 does not correspond to that of an image captured by the digital camera 120 and represented on the camera display 120. Users are not able to precisely identify the surveying point 34 on the camera display 120 or the captured image. The value dHL is the horizontal offset quantity, and the value dVL is the vertical offset quantity. The difference between the shot mark and the aiming point 34 in an image is caused by this offset, and the amount of difference on the camera display 123 is the difference quantity. The error detecting process begins with calculating the difference quantity. The difference quantity calculating process is described below with reference to FIGS. 4 and 5.

After the distance L between the total station 100 and the surveying object 33 is measured, the imaging device 121 photographs the surveying object 33 with its surroundings, and the captured image is shown in the camera display 123. The center point 35 of an image shown in the camera display 123 does not correspond to the aiming point 34 located on the optical axis 37 of the telescopic optical system 39, because the optical axis 36 of an imaging optical system 38 does not correspond to the optical axis 37 of the telescopic optical system 39.

The position of a difference-corrected point 41 in which the offset between the optical axis 36 and the optical axis 37, i.e., the difference between the center of the shot mark and the aiming point 34 on the camera display 123, in corrected, is calculated. In this case, the position of the difference-corrected point 41 and the center point 35 differ by an amount corresponding to the offset between the imaging optical axis 36 and the telescopic optical axis 37. The offset quantity between the center point 35 of an image and the difference-corrected point 41 is described an dHLp in the horizontal plane, and dVLp in the vertical plane. The difference-corrected point 41 indicates a position to correct offset quantities, and not to correct direction error. The unit of the offset quantities is a number of pixels, and the method of calculating each offset quantity is described below.
dHLp=(ArcTan(dHL/L))/RXnθ
dVLp=(ArcTan(dVL/L))/RYnθ

L is the distance between the total station 100 and the surveying object 33 surveyed by the distance meter 110. The distance L is measured when a user directing the telescope 111 towards the surveying object 33 in step S21 and 322 of the superimposing process.

RXnθ and RYnθ are the horizontal and vertical resolutions per pixel of the CCD. The resolution is calculated by dividing the angle of view of the pixels in the CCD, which is decided according to the focal length of the lens, by the horizontal or vertical number of pixels.

A point mark 42 is displayed on a difference-corrected point 41, which is moved from the center of an image 35 by offset quantities dHLp and dVLp. The point mark 42 is a way of indicating the position of a surveyed aiming point 34, and is represented by a cross. The offset quantities dHLp and dVLp are stored in the survey memory 116 as initial values E0 of the direction error data.

The process of calculating direction error data is described below.

A typical user surveys outside during daytime, and a digital camera and members constituting a telescope may expand and contract due to a change of temperature and radiated heat from the sun. Direction errors, caused by the angle which is produced by crossing the optical axis of the telescopic optical system and the optical axis of the imaging optical system, can be experienced. These direction errors prevent a user from precisely directing the total station at a surveying object 33 with reference to an image on a display.

The total station 100 shown in FIG. 4 has a direction error between the imaging optical axis 36 and the standard axis 31. The standard axis is shown to be parallel to the telescopic optical axis 37, and the direction error is exaggerated in the figure. The value dHAp is the horizontal direction error, and the value dVAp in a vertical direction error. Each direction error is described as a number of pixels.

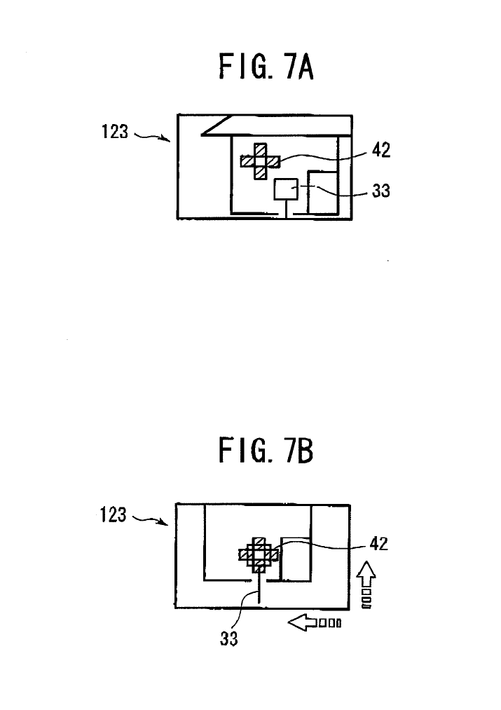

With reference to FIG. 5, the point mark 42 is displayed coincident with the difference-corrected point 41 on the camera display 123. A user operates the input device 115 with reference to an image and a point mark 42 on the camera display 123. With reference to FIG. 7, it can be seen that due to the operation by a user, the point mark 42 can be made coincident with the surveying object 33 in the camera display 123. The movement vector of an image in the horizontal direction is dHAp, and the movement vector in the vertical direction is dVAp. The movement vector corresponds to a direction error.

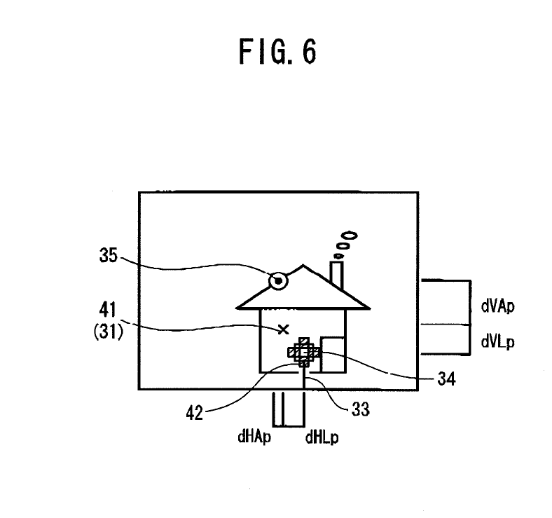

The actual position of the surveying point 34 differs, by an amount corresponding to the errors dHLp and dHAp in the horizontal plane and the errors dVLp and dVAp vertical plane, from the center point of the image (refer to FIG. 6).

The direction error is added to direction error data E0, and stored in the survey memory 116, as the latest direction error data E1. When a direction error is calculated for a surveying object 33 which has the same distance L, the direction error data E1 is retrieved, and added to the direction error calculated at this time. The direction error data which is added to the direction error is stored in the survey memory 116 as the latest direction error data E2, and saved in the memory medium 125 with Information associating the direction error data E2 and a photographed image. The direction error data En is added every time a direction error is calculated.

The standard axis 31 and the imaging optical axis 36 create a direction error angle. The direction error angle is calculated from dHAp and dVAp; the direction error angle in the horizontal plane is dHAp, and in the vertical plane is dVAp. The angles dHAp and dVAp are calculated by formulae as described below.
dHθ=dHAp·RXnθ
dVθ=dVAp·RYnθ

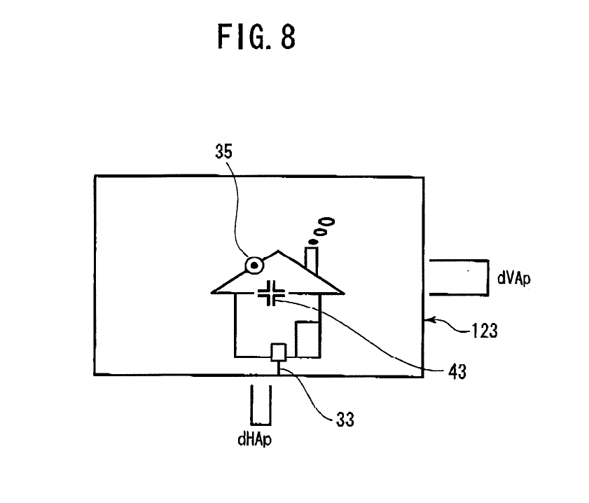

The position of the shot mark 43 is calculated using a direction error angle which is obtained by dividing the direction error by the resolution in step S23 and S24. On the camera display in FIG. 8, the shot mark 43 is displayed at a location differing by an amount dHAp in the horizontal plane and dVAp in the vertical plane from the center of the image. Therefore, a user can roughly recognize the location of a survey point to be surveyed.

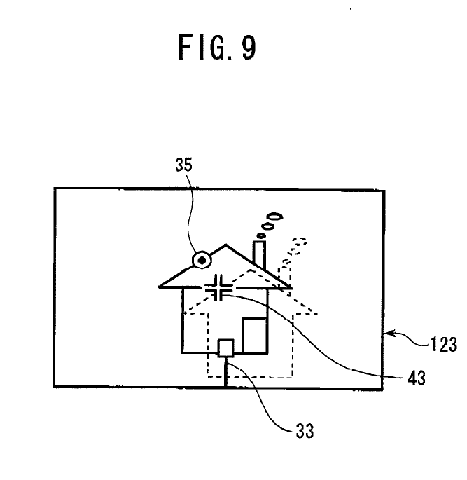

The image displayed on the camera display 123 is automatically moved by a distance dHLp+dHAp horizontally and a distance dVLp+dVAp vertically, so that the position of the shot mark 43 corresponds to the center point of the camera display 123. Before the image is moved, the camera display 123 acts as a window onto the captured image; the peripheral area of the captured image are not displayed and the displayed part fills the camera display 123. After the movement, the shot mark 43 corresponds to the center point of the camera display 123, so that a user can collimate the aiming point to the surveying object 33 by watching the camera display 123, more easily (refer to FIG. 9). Note that, while the captured image is moved when the values of dHLp, dHAp, dVLp, and dVAp are calculated in the present embodiment, the captured image may also be voluntarily moved by a user operating the input device 115.

According to this embodiment, the total station comprises a telescope having a bright f-number. A user can roughly recognize the location of a surveying object 33 to be surveyed.

Note that, while the captured image is moved in the embodiment, the shot mark 42 on the camera display 123 may be moved so that the shot mark 43 corresponds to a surveying object 33.

Moreover, the memory medium 125 is not limited to being a detachable memory card, but may also be any storage medium provided in a digital camera.

Although the embodiment of the present invention has been described herein with reference to the accompanying drawings, obviously many modifications and changes may be made by those skilled in the art without departing from the scope of the invention.

The present disclosure relates to subject matter contained in Japanese Patent Application No. 2006-183934 (filed on Jul. 3, 2006), which is expressly incorporated herein, by reference, in its entirety.

1. A surveying apparatus comprising:
a telescope that collimates the aiming point on a surveying object;
a digital camera that has an imaging optical system provided independently from the telescopic optical system of said telescope;
a display device that shows an image captured by said digital camera;
a measuring device that measures a distance between said telescope and a surveying point to be surveyed; and
a superimposing device that displays a shot mark, which roughly indicates the location of the surveying point in the image, on said display device.

2. The surveying apparatus according to claim 1, wherein the shot mark is shown in the center of a display area of said display device.

3. The surveying apparatus according to claim 1 comprising;
an axis error detecting device that detects the direction error between the optical axis of the telescope optical system and the optical axis of the imaging optical system, and stores error data corresponding to the direction error;
the position of the shot mark in the image is corrected by the direction error.

4. The surveying apparatus according to claim 1 comprising;
as axis error detecting device that detects the direction error between the optical axis of the telescope optical system and the optical axis of the imaging optical system, and stores error data corresponding to the direction error;
the position of the image being corrected by the direction error in order to display the shot mark at the center of said display device.

5. The surveying apparatus according to claim 3 further comprising an input device that relatively moves the shot mark and the surveying object in the image so that the shot mark corresponds with the aiming point in the image.

6. The surveying apparatus according to claim 5 further comprising a memory device that stores error data, and said axis error detecting device detects the movement distance of the image or the shot mark as the error data.

7. The surveying apparatus according to claim 4 further comprising an input device that relatively moves the shot mark and the surveying object in the image so that the shot mark corresponds with the aiming point in the image.

8. The surveying apparatus according to claim 7 further comprising a memory device that stores error data, and said axis error detecting device detects the movement distance of the image or the shot mark as the error data.
